(19) United States
(12) Patent Application Publication
(10) Pub. No.: US 2011/0253060 A1
(43) Pub. Date: Oct. 20, 2011

(54) PET SCRATCHING APPARATUSES

(76) Inventors: Randy Schotthoefer, Hillsboro, OR (US); Robert Hunter, Stayton, OR (US)

(21) Appl. No.: 13/088,388

(22) Filed: Apr. 17, 2011

Related U.S. Application Data
(60) Provisional application No. 61/325,691, filed on Apr. 19, 2010.

(51) Int. Cl. A01K 13/00; A01K 15/02

(52) U.S. Cl. 119/706

(57) ABSTRACT

A pet scratching apparatus including a base defining a top face and a scratching element extending vertically from the top face of the base, the scratching element including an internal member the top face of the base and defining an exterior surface and a scratchable sleeve removably mounted on the exterior surface of the internal member. In some examples, the pet scratching apparatus includes two bases. In some further examples, the pet scratching apparatus includes a connection system.

### BACKGROUND

The present disclosure relates generally to pet scratching apparatuses. In particular, pet scratching apparatuses with removable and replaceable scratching sleeves are described.

Generally, pet scratching apparatuses provide an acceptable location for pets to scratch and in turn reduce harm to other household property. There exists a particularly strong need for pet scratching apparatuses in households with pets that have a natural urge to scratch, such as housecats. This disclosure is directed to pet scratching apparatuses including a modular design with interchangeable elements.

Present designs of pet scratching apparatuses are not entirely satisfactory. For example, many known pet scratching apparatuses have a design that requires replacement of the entire apparatus when individual components are worn. Because scratching surfaces primarily suffer the most damage during normal use, they often become worn far sooner than the other elements of pet scratching apparatuses. Many known pet scratching apparatuses require replacement of the entire apparatus when this expected damage occurs. Because the other elements of the pet scratching apparatuses that must be disposed are often in working condition at the time, many known pet scratching apparatuses produce a great deal of waste.

Additionally, known pet scratching apparatuses are often difficult to adapt to different contexts and/or locations, because they often define static apparatuses configured for a single purpose. The static, non-modular design of many known pet scratching apparatuses makes it difficult to augment their functionality with additional scratching elements.

Thus, there exists a need for scratch post apparatuses that improve upon and advance the design of known scratch posts. Examples of new and useful scratch post apparatuses relevant to the needs existing in the field are discussed below.

### SUMMARY

This disclosure is directed to a pet scratching apparatus including a base defining a top face and a scratching element extending vertically from the top face of the base, the scratching element including an internal member the top face of the base and defining an exterior surface and a scratchable sleeve removably mounted on the exterior surface of the internal member. In some examples, the pet scratching apparatus includes two bases. In some further examples, the pet scratching apparatus includes a connection system.

### BRIEF DESCRIPTION OF THE DRAWINGS

FIG. 1 is a perspective view of a first example of a pet scratching apparatus.

FIG. 2 is a exploded view of the pet scratching apparatus shown in FIG. 1.

FIG. 3A is a perspective view of a first example of a scratching element configured for use with a pet scratching apparatus.

FIG. 3B is a perspective view of a second example of a scratching element configured for use with a pet scratching apparatus.

FIG. 3C is a perspective view of a third example of a scratching element configured for use with a pet scratching apparatus.

FIG. 3D is a perspective view of a fourth example of a scratching element configured for use with a pet scratching apparatus.

FIG. 3E is a perspective view of a fifth example of a scratching element configured for use with a pet scratching apparatus.

FIG. 3F is a perspective view of a sixth example of a scratching element configured for use with a pet scratching apparatus.

FIG. 4A is a perspective view of a first example of a base configured for use with a pet scratching apparatus.

FIG. 4B is a perspective view of a second example of a base configured for use with a pet scratching apparatus.

FIG. 4C is a perspective view of a third example of a base configured for use with a pet scratching apparatus.

FIG. 5 is a perspective view of a second example of a pet scratching apparatus.

FIG. 6 is a perspective view of the base of the pet scratching apparatus illustrated in FIG. 5.

FIG. 7 is a perspective view of a third example of a pet scratching apparatus.

FIG. 8 is an exploded view of the pet scratching apparatus in FIG. 7.

FIG. 9 is a perspective view of a fourth example of a pet scratching apparatus.

FIG. 10 is an exploded view of the pet scratching apparatus in FIG. 9.

### DETAILED DESCRIPTION

The disclosed pet scratching apparatuses will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various pet scratching apparatuses are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

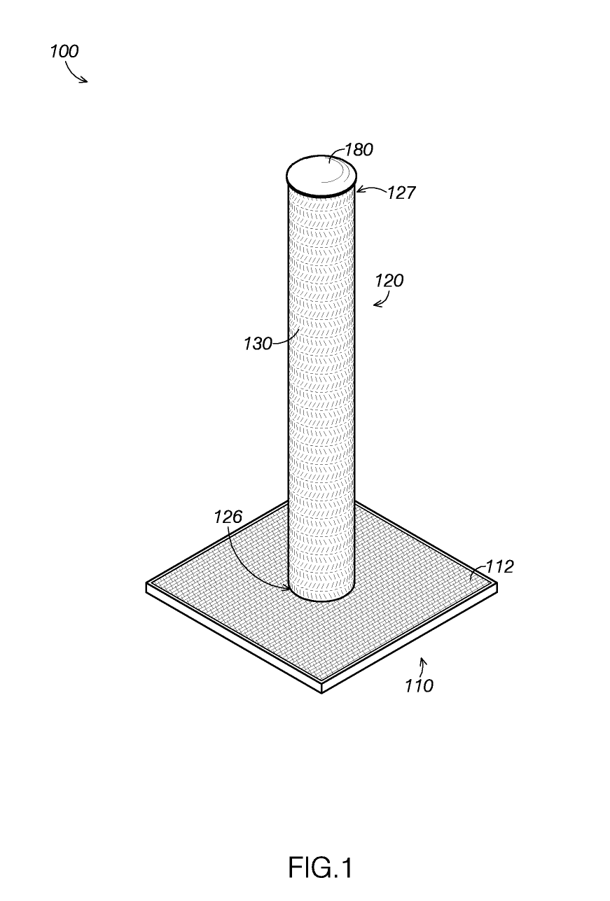

With reference to FIG. 1, a pet scratching apparatus 100 includes a base 110, a scratching element 120, a connection system 127, and a cap 180. Pet scratching apparatus 100 provides pets with an object that they may scratch without damaging other household property. Pet scratching apparatus 100 additionally allows a user to replace the surfaces of base 110 and scratching element 120, as well as replacement of base 110 and scratching element 120. Replacing just the worn surface of these elements avoids the need to replace the entire device as a whole. The ability to replace scratching surfaces allows the user to attach additional or alternative surfaces made of a variety of materials.

Additionally, pet scratching apparatus 100 includes connection system 127, which allows base 110 to be paired with compatible scratching elements other than scratching element 120. Likewise, connection system 127 allows scratching element 120 to be paired with compatible bases other than base 110. This interchangeability affords pet scratching apparatus 100 greater adaptability by allowing the connection of scratching elements other than the specific one disclosed.

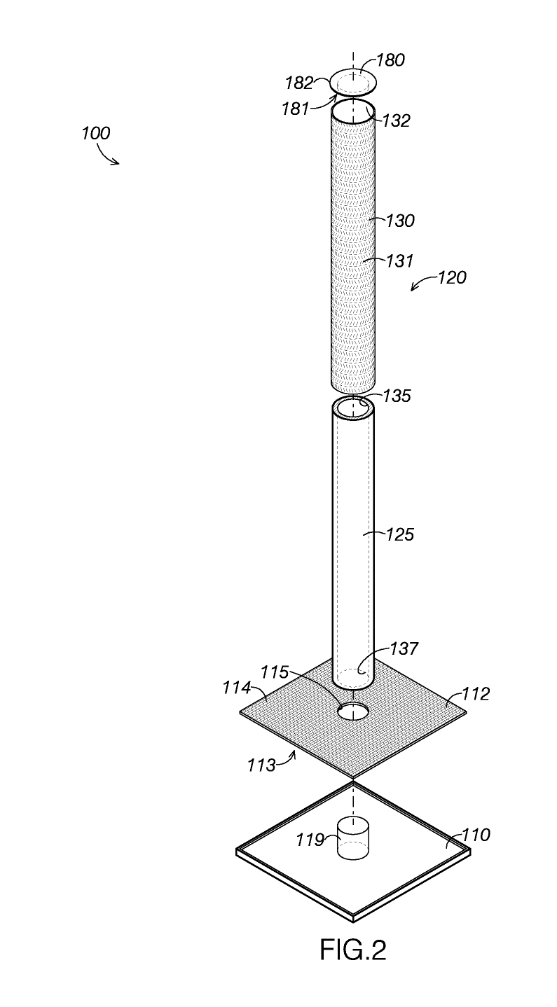

As FIGS. 1 and 2 show, base 110 defines a substantially rectangular rigid body defining a top face 117. Base 110 is configured to be placed on a supporting surface, such as a floor. Base 110 includes a base covering 112 on a top face of base 110 and a base male connector 119. Base 110 detachably connects to scratching element 120 by base male connector 119. When scratching element 120 is so connected, base 110 provides support to retain scratching element 120 in a substantially stable, upright position. Base 110 is additionally configured to support removable base covering 112, providing a scratchable surface area on the top of base 110.

Base covering 112 defines an area of carpet removably mounted on top of base 110 and includes an opening 115 near its center configured to receive base male connector 119. Base covering 112 additionally includes a backing 113 and a pile 114. Base covering 112 provides a scratchable surface area on base 110 and provides protection to base 110's underlying structure, extending the useful life of base 110 during normal operation.

Pile 114 defines a collection of tightly collected threads configured to resist damage resulting from pet scratching, the threads maintained in close proximity by backing 113. Backing 113 also provides a tacky rubber surface that substantially retains base covering 112 in position when mounted on base 110. Pile 114 and backing 113 collectively provide a detachable scratching surface and protective layer to base 110's surface.

Although base covering 112 defines carpet including a backing 113 and pile 114, this design is not specifically required. The base covering may be made of a single material, on both the top and bottom. Additionally, base coverings may be composed, in whole or part, of other protective materials to prevent scratching and other damage. Such materials may include, but are not limited to, ropes, canvases, cushions, twines, and/or woods. Additionally, base coverings include retaining materials, such as adhesives.

Opening 115 defines an aperture through base covering 112 configured to receive base male connector 119. Opening 115 is smaller than scratching element 120, allowing scratching element 120 to retain base covering 112 in place when it is coupled with base 110. Opening 115 allows base covering 112 to be removably mounted on base 110 when scratching element 120 is connected to base 110 via connection system 127.

Scratching element 120 includes an internal member 125, a bottom opening 137, a top opening 135, and a scratchable sleeve 130. Scratching element 120 provides a vertically extending post that affords a pet a scratchable surface area. Scratching element 120 is supported in a substantially upright position on base 110 via base male connector 119 and extends from a bottom connected to top face 117 to a top opposite the bottom.

Scratching element 120 allows easy removal and/or replacement of scratchable sleeve 130, which may extend the useful life of internal member 125 Specifically, a user may slidingly remove scratchable sleeve 130 when cap 180 is detached. When scratchable sleeve is removed, a user may place alternative scratching sleeves on internal member 125. For example the alternative scratching sleeves may be made of a different material or have a different design than scratchable sleeve 130.

Internal member 125 defines a substantially cylindrical and rigid tube that extends from base 110 on a first side 126 to a second side 127 opposite first side 126. Internal member 125 includes an exterior surface 128 defined by its outer perimeter along its length. Internal member 125 provides the primary structural support to scratching element 120. The rigidity of internal member 125 supports scratching element 120 in an upright position relative to base 110. Internal member 125 is configured to support sleeve 130 around its perimeter and has a diameter slightly smaller than the diameter of scratchable sleeve 130.

In the example shown in FIGS. 1 and 2, scratchable sleeve 130 defines a tube shaped similar to internal member 125 with a slightly larger diameter. Scratchable sleeve 130 is configured to be slidingly mounted on internal member 125 when cap 180 is removed from top opening 135.

Scratchable sleeve 130 may be made of a similar or identical material as base covering 112. In some examples, the scratchable sleeve is made from carpet. Similar to base covering 112, scratchable sleeve 130 includes a pile 131 and a backing 132. Scratchable sleeve 130 is provides a scratching surface and a protective layer around internal member 125.

While scratchable sleeve 130 is an area of carpet rolled into a tube, sleeves may be composed, in whole or part, of other protective materials to reduce or prevent damage to internal member 125. Such materials may include, but are not limited to, ropes, canvases, cushions, twines, and/or woods. Additionally, sleeves may include other retaining materials, such as adhesives.

Bottom opening 137 is configured to receive base male connector 119 located on the first side of internal member 125. When base male connector 119 is engaged within bottom opening 137, scratching element 120 is supported from base 110 in a substantially upright position.

Top opening 135 is located on second side 127. Top opening 135 is substantially similar to bottom opening 137 and is configured to receive cap 180.

Cap 180 defines a substantially circular body configured to engage within top opening 135 and retain scratchable sleeve 130 on internal member 125 when so engaged. Cap 180 includes a retaining element 182 and a male connector 181. Male connector 181 is configured to engage within top opening 135. Retaining element 182 extends to a diameter equal or greater to that of scratchable sleeve 130. As a result, retaining element 182 retains scratchable sleeve 130 in position when male connector 181 is engaged within top opening 135.

Connection system 127 serves to retain scratching element 120 affixed to and supported by base 110. Connection system 127 includes base male connector 119, bottom opening 137, top opening 135, and male connector 181. Bottom opening 137 is configured to receive base male connector 119 to a sufficient depth to retain scratching element 120 in place on base male connector 119.

However, the particular connection system design shown in FIGS. 1 and 2 is not at the heart of the inventive subject matter. Rather, this disclosure is directed more, in relevant part, to the interconnection of modular, interchangeable pet scratching components into a complete apparatus. Generally, connection systems may include any number of “connection system connectors,” which specifically includes the disclosed male members, female members, and their functional equivalents.

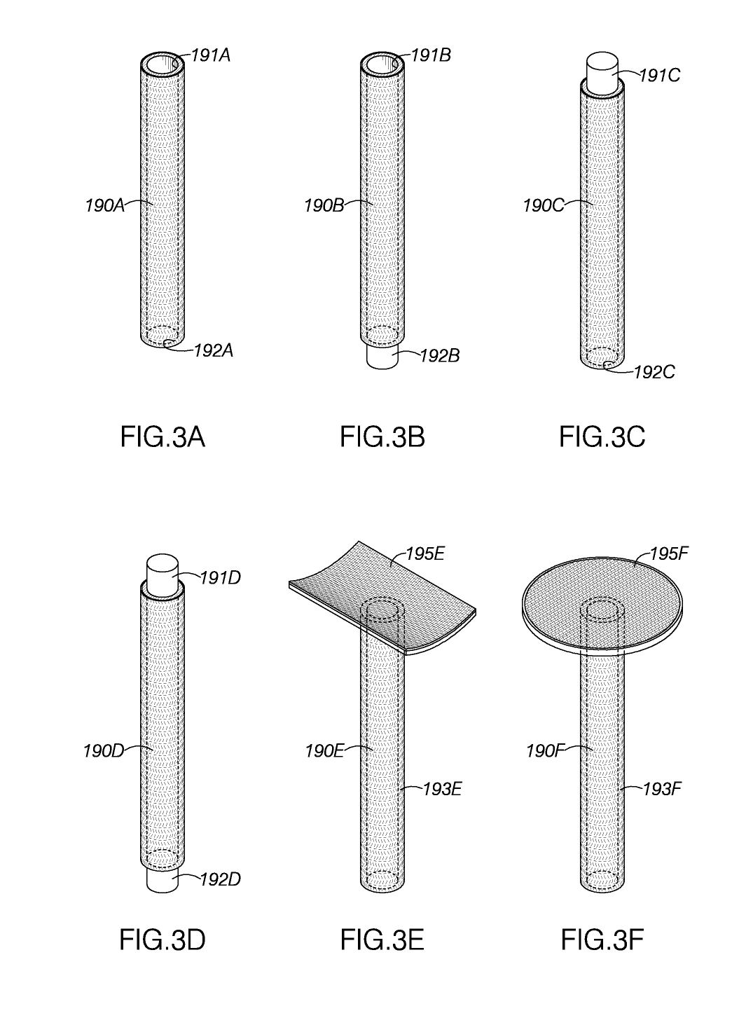

Scratching element 120 defines a substantially tubular member defining openings at both ends. However, this specific shape is not required. FIGS. 3A-3F illustrate a non-exclusive collection of alternative scratching element designs.

FIGS. 3A-3D illustrate scratching elements with various arrangements of connection system connectors and openings.

FIG. 3A illustrates a scratching element 190A with an opening 191A on the top of scratching element 190A and an opening 192A on the bottom of scratching element 190A.

FIG. 3B illustrates a scratching element 190B with an opening 191B positioned on the top of scratching element 190B and a male connector 192B positioned on the bottom of scratching element 190B.

FIG. 3C illustrates a scratching element 190C that includes a male connector 191C positioned on the top of the scratching element and an opening 192C positioned on the bottom of scratching element 190C.

FIG. 3D illustrates a scratching element 190D with a male connector 191D positioned on the top of scratching element 190D and a male connector 192D on the bottom of scratching element 190D.

FIGS. 3E-3F illustrate two non-exclusive variations on the shape of a scratching element.

FIG. 3E illustrates a scratching element 190E that defines a post 193E that extends vertically to connect with a platform 195E. Platform 195E substantially defines a bisected tube with a concave top side opposite scratching element 190E.

FIG. 3F illustrates a scratching element 190F that that defines a post 193F that extends vertically to a platform 195F. Platform 195F substantially defines a short cylinder or disk with a top side opposite scratching element 190F.

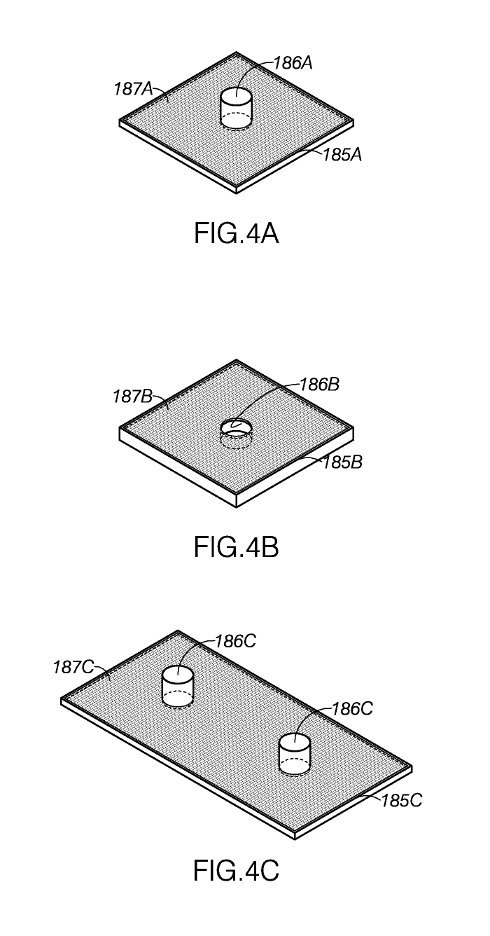

FIG. 4 illustrates three non-exclusive base variations. FIG. 4A illustrates a base 185A with a single male connector 186A projecting near base 185A's center. FIG. 4B illustrates a base 185B including a single female connector 186B positioned on its top. FIG. 4C illustrates a base 185C that includes a plurality of male connectors 186C projecting from its top.

In embodiments including an alternative base design, a corresponding change to the base covering may also be made. Accordingly, base 185A, base 185B, and base 185C include a base covering 187A, a base covering 187B, and a base covering 187C, respectively. Base covering 187A, base covering 187B, and base covering 187C include openings that are substantially aligned with features on the top of the corresponding base. More generally, base coverings according to this disclosure are not limited to a single particular shape or design, but rather are generally designed to complement the base upon which they mount.

Base 110 is described as having a specific shape. However, bases are not limited to any particular shape or size of connection system adapters. Bases according to this disclosure may be of any self-supporting shape and design, and may include any number of connection system adapters.

Additionally or alternatively, this disclosure specifically contemplates attaching bases to either side of scratching elements in both elevated and non-elevated positions. In elevated positions, bases may substantially define a platform. In these and other embodiments, bases according to this disclosure may specifically include scratchable surface mounted on both their tops and their bottoms.

More generally, the system described discusses the particular elements as being either scratching elements or bases. However, this does not adequately describe the modular nature of pet scratching apparatuses according to this disclosure. This disclosure considers the use of the disclosed connection system and removable sleeves affixed to elements of various shapes and sizes. Through the disclosed connection system, various scratching elements, bases, or other elements including the connection system may be linked together to create a pet scratching apparatus with several supports and scratchable surfaces. This allows a user to personally select a number of compatible elements that is suited for their particular pet or pets.

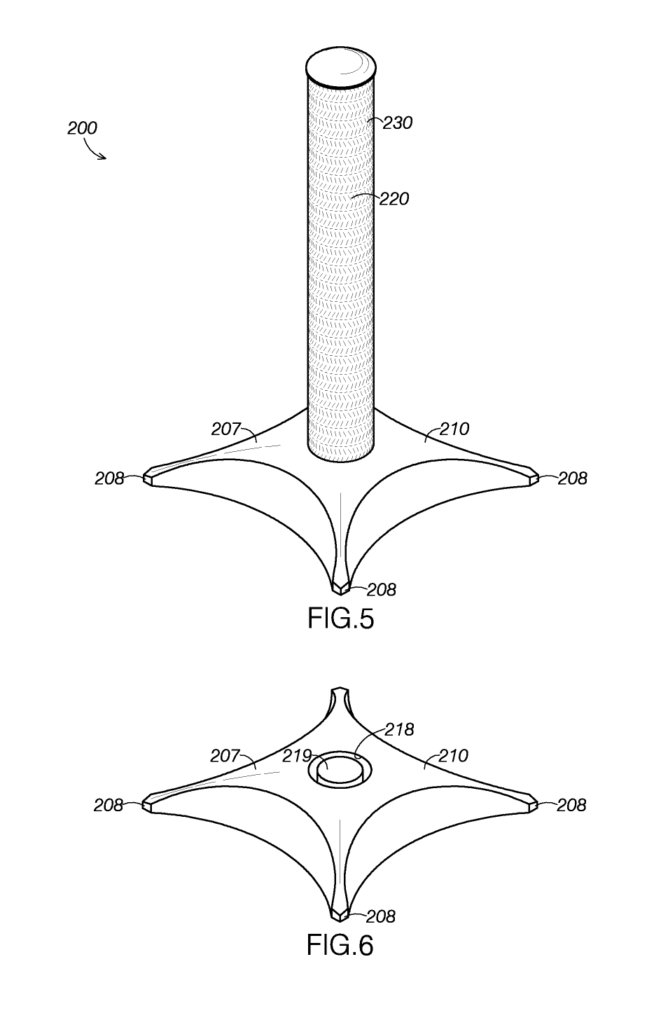

Turning attention to FIGS. 5 and 6, a second example of a pet scratching apparatus 200 will now be described. Pet scratching apparatus 200 includes many similar or identical features to pet scratching apparatus 200 combined in unique and distinct ways. Thus, for the sake of brevity, each feature of pet scratching apparatus 200 will not be redundantly explained. Rather, key distinctions between pet scratching apparatus 200 and pet scratching apparatus 100 will be described in detail and the reader should reference the discussion above for features substantially similar between the two pet scratching apparatuses.

As can be seen in FIGS. 5 and 6, pet scratching apparatus 200 includes a base 210 and a scratching element 220. Similar to pet scratching apparatus 100, scratching element 220 projects vertically from the top of base 210 and is removable. Scratching element 220 additionally includes a removable, scratchable sleeve 230 mounted around its perimeter.

Similar to base 110, base 210 supports scratching element 220. As FIGS. 5 and 6 show, base 210 defines an elevated, curved surface 207 supported by four legs 208 positioned around the perimeter of base 210. Base 210 is positioned on the bottom of pet scratching apparatus 200 and is configured to support scratching element 220.

FIG. 6 illustrates one difference between pet scratching apparatus 100 and pet scratching apparatus 200. Specifically, base 210 includes a recess 218 and a base male connector 219 at the bottom of recess 218. Base male connector 219 projects vertically from recess 218 and is configured to support scratching element 220 mounted on base male connector 219 within recess 218. In this particular example, the top of base male connector 219 is substantially aligned with curved surface 207.

As FIG. 6 shows, base 210 includes four legs 208 positioned around the perimeter of base 210. Legs 208 provide lateral support to base 210. Lateral support from legs 208 helps resist pet scratching apparatus 200 from tipping.

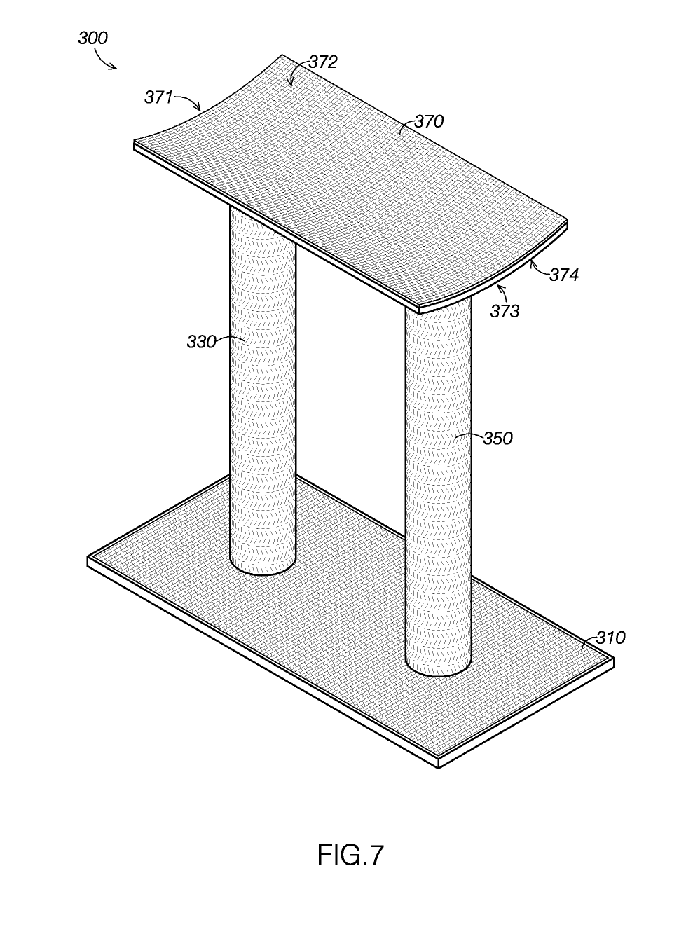

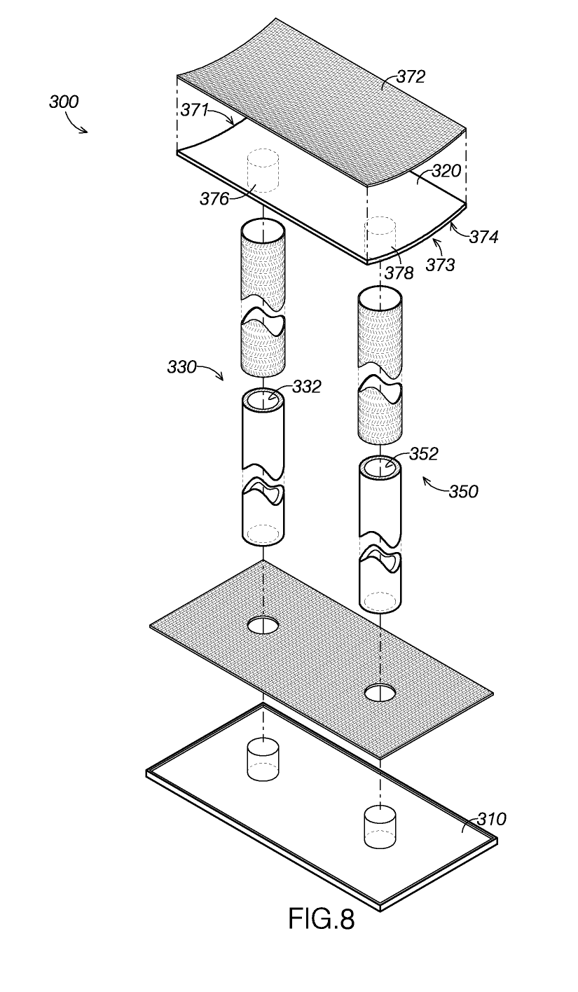

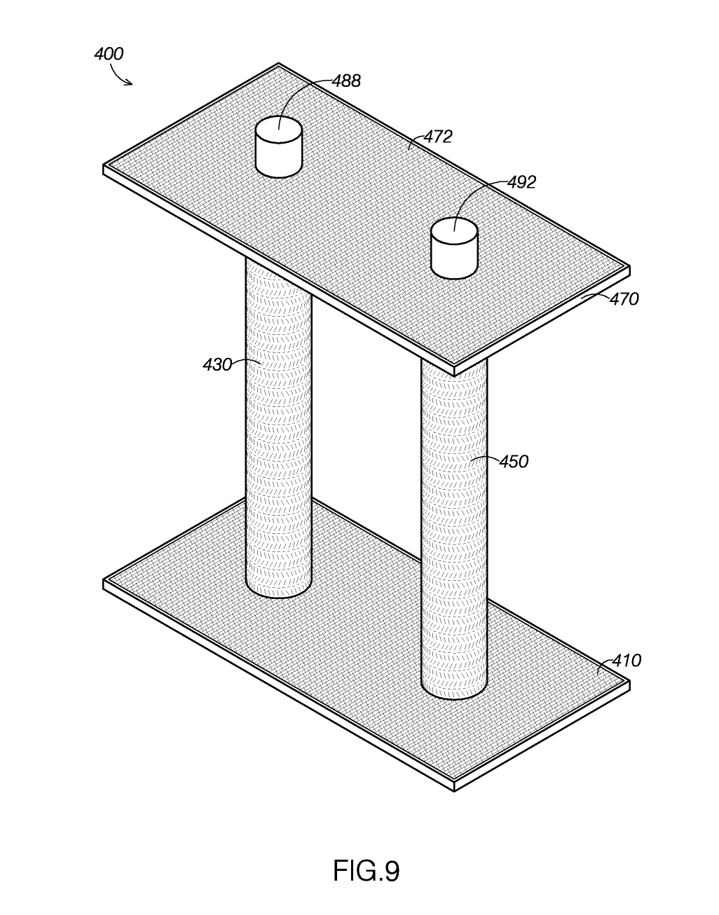

Turning attention to FIGS. 7 and 8, a third example of a pet scratching apparatus, pet scratching apparatus 300, will now be described. Pet scratching apparatus 300 includes many similar or identical features to pet scratching apparatus 100 combined in unique and distinct ways. Thus, for the sake of brevity, each feature of pet scratching apparatus 300 will not be redundantly explained. Rather, key distinctions between pet scratching apparatus 300 and pet scratching apparatus 100 will be described in detail and the reader should reference the discussion above for features substantially similar between the two pet scratching apparatuses.

As FIGS. 7 and 8 illustrate, pet scratching apparatus 300 includes a base 310, a first scratching element 330, a second scratching element 350, and a platform 370. Pet scratching apparatus 300 is configured to provide a multiple post scratch post with an elevated platform above the posts. This provides pets a variety of scratchable surface areas and an additional surface to stand on.

First scratching element 330 and second scratching element 350 are substantially similar to scratching element 120, extending vertically from base 310 to a top. As shown in FIG. 8, first scratching element 330 and second scratching element 350 include a female connector 332 and a female connector 352, respectively, positioned on their tops. Female connector 332 and female connector 352 are configured to receive corresponding male connectors projecting from platform 370.

As FIGS. 7 and 8 illustrate, platform 370 defines a half-cylinder shape with a concave top surface 372 and a convex bottom curved surface 374. Platform 370 extends from a first side 371 to a second side 373. Platform 370 includes a first male connector 376 and a second male connector 378. Platform 370 provides pets with an additional location to stand, sit or lay on pet scratching apparatus 300. Additionally, platform 370 provides a pet with a climbing and jumping play space.

First male connector 376 is proximate first side 371 and extends downward from the bottom of platform 370. First male connector 376 defines a projection similar to base male connector 119 and is configured to be received by female connector 332.

Second male connector 378 is proximate second side 373 and extends downward from the bottom of platform 370. Second male connector 378 defines a projection similar to base male connector 119 and is configured to be received by female connector 352.

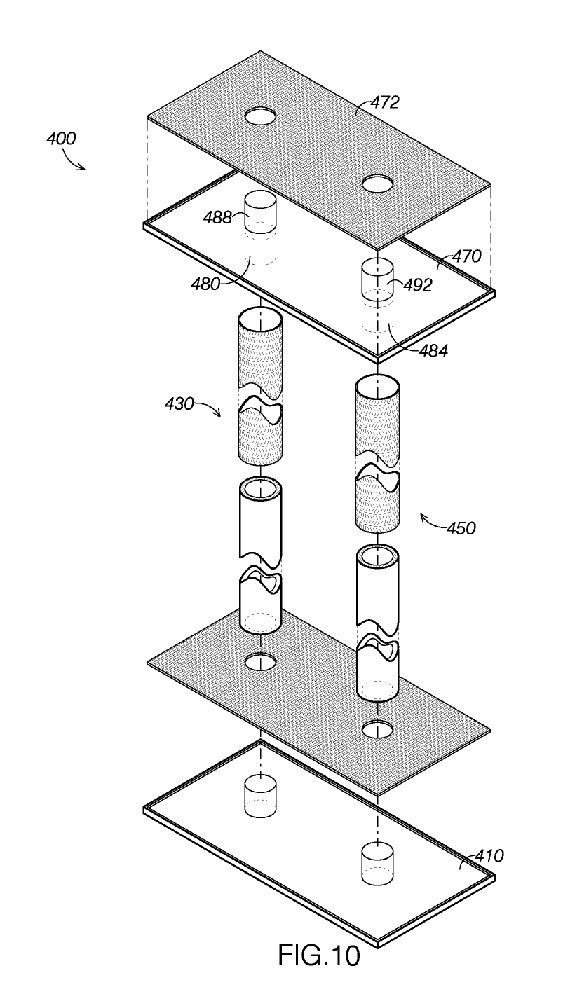

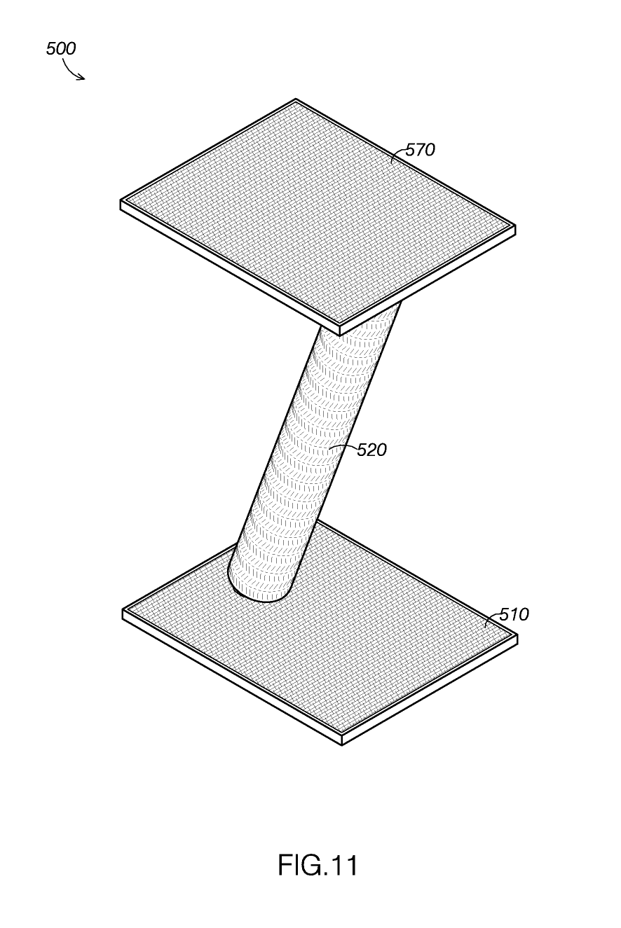

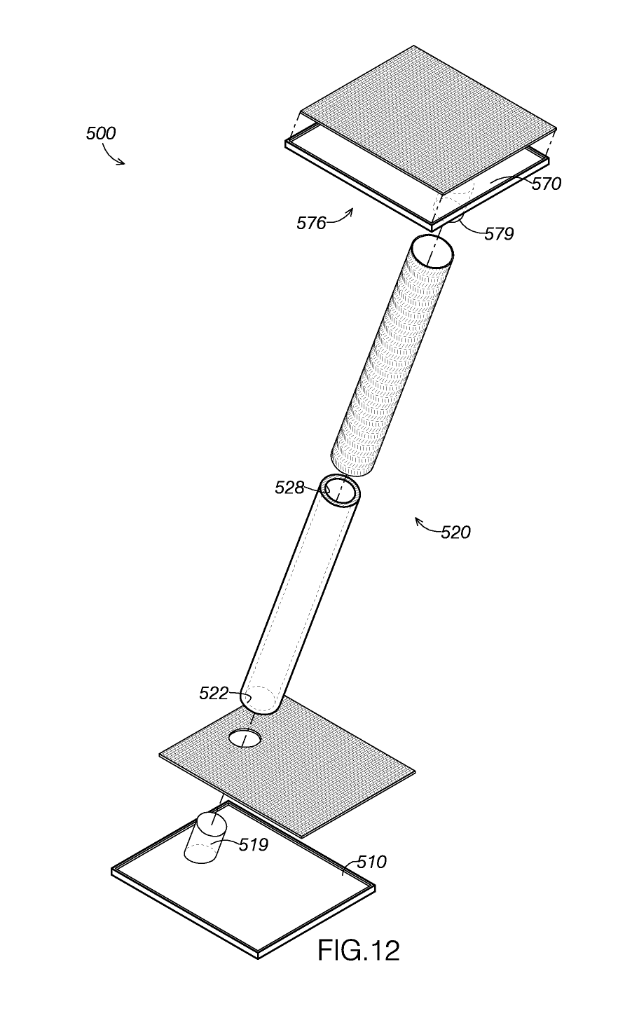

Turning attention to FIGS. 9 and 10, pet scratching apparatus 400 is substantially similar to pet scratching apparatus 300; however, pet scratching apparatus 400 provides additional male connectors on top of a platform to allow further expansion.

As FIGS. 9 and 10 illustrate, pet scratching apparatus 400 includes a base 410, a first scratching element 430, a second scratching element 450, and a platform 470. Base 410, first scratching element 430, and second scratching element 450 are substantially similar to base 310, first scratching element 330, and second scratching element 350, respectively.

Platform 470, however, differs from platform 370. With reference to FIG. 10, platform 470 defines a rectangular body, including a top scratchable surface 472 and a bottom scratchable surface. Platform 470 additionally includes a first platform bottom male connector 480, a second platform bottom male connector 484, a first platform top male connector 488, and a second platform top male connector 492, each substantially similar to base male connector 119.

Platform 470 generally provides the benefits discussed in relation to platform 370. However, the additional male connectors on top scratchable surface 472 allow a user to modify pet scratching apparatus 400 by attaching additional elements that include female members compatible with first platform top male connector 488 and/or second platform top male connector 492.

Turning attention to FIGS. 11-12, a fifth example of a pet scratching apparatus, pet scratching apparatus 500, will now be described. Pet scratching apparatus 500 includes many similar or identical features to pet scratching apparatus 100 combined in unique and distinct ways. Thus, for the sake of brevity, each feature of pet scratching apparatus 500 will not be redundantly explained.

As FIGS. 11-12 show, pet scratching apparatus 500 includes a first base 510, a scratching element 520, and a second base 570. Scratching element 520 extends diagonally between first base 510 and second base 570, connecting to first base 510 and second base 570 at a non-perpendicular angle. Pet scratching apparatus 500 is configured to support itself from the ground or other external surface by resting on coplanar edges of first base 510 and second base 570. Alternatively, pet scratching apparatus 500 may support itself from the ground or other external surface by resting on the outer face of either first base 510 or second base 570.

First base 510 defines a base substantially similar to base 110. However, first base 510 includes a first base male connector 519 that extends from first base 510 at a non-perpendicular angle. First base male connector 519 is configured to couple with support scratching element 520.

Second base 570 also defines a base substantially similar to base 110, spaced from first base 510. Similar to first base 510, second base 570 includes a second base male connector 579 on an interior side 576 of second base 570. Second base male connector 579 extends at a non-perpendicular angle relative to second base 570 toward first base 510. Second base male connector 579 is substantially opposed to first base male connector 519.

Scratching element 520 defines a post similar to scratching element 120 and extends between first base 510 and second base 570. Scratching element 520 includes a first opening 522 configured to couple with the first base male connector 519 at a non-perpendicular angle relative to first base 510. Scratching element 520 additionally includes a second opening 528 configured to couple with the second base male connector 579 at a non-perpendicular angle relative to second base 570.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

What is claimed is:

1. A pet scratching apparatus, comprising:
a base defining a top face;
a scratching element extending vertically from the top face of the base, the scratching element including:
an internal member extending from the top face of the base and defining an exterior surface; and
a scratchable sleeve removably mounted on the exterior surface of the internal member.

2. The pet scratching apparatus of claim 1, further comprising a base covering removably mounted on the top face of the base and defining an opening near the its center to receive the internal member.

3. The pet scratching apparatus of claim 1, wherein the internal member substantially defines a tube.

4. The pet scratching apparatus of claim 1, further comprising:
a cap removably connected to the internal member opposite the base, the cap including:
a retaining element extending beyond the perimeter of the scratching element; and
a male connector extending downward from the cap, the projection similarly sized and shaped to the top female connector.

5. The pet scratching apparatus of claim 1, wherein the base defines a first base, and further comprising:
a second base connected to the internal member, the second base defining a second base bottom face substantially facing the top face of the base; and
a male connector extending from the second base bottom.

6. The pet scratching apparatus of claim 5, further comprising:
a scratching surface substantially covering a top face of the second base.

7. The pet scratching apparatus of claim 1, wherein the internal member includes a male connector on its bottom.

8. The pet scratching apparatus of claim 1, wherein the scratching element includes a male connector at an end distal the base.

9. The pet scratching apparatus of claim 1, wherein the base includes a male connector extending from its top face.

10. The pet scratching apparatus of claim 1, wherein the base includes a recess configured to receive a male connector.

11. The pet scratching apparatus of claim 1, wherein the scratching element includes a platform attached to a top end distal the base.

12. The pet scratching apparatus of claim 11, wherein the shape of the platform substantially defines a bisected tube having an internal curved side opposite the scratching element.

13. The pet scratching apparatus of claim 11, wherein the platform includes a recess on a first side opposite the scratching element.

14. The pet scratching apparatus of claim 1, wherein the base includes:
a recess positioned near its center configured to receive the scratching element; and
a male connector projecting upward near the center of the recess.

15. A pet scratching apparatus, comprising:
a first base including a top face and a first male connector extending from the top face;
a second base including a bottom face facing the top face and a second male connector extending from the bottom face; and
a scratching element including:
an inner tube having a lateral exterior surface, a first end, and a second longitudinal end; and
a scratching sleeve removably covering the lateral exterior surface, the first longitudinal end of the inner tube receiving the first male connector and the second longitudinal end of the inner tube receiving the second male connector.

16. The pet scratching apparatus of claim 14, wherein the first longitudinal end couples with the first male connector perpendicular to the first base; and
wherein the second longitudinal end is configured to couple with the second male connector perpendicular to the second base.

17. The pet scratching apparatus of claim 14, wherein:
the first longitudinal end is configured to couple with the first base female connector at an angle other than 90 degrees; and
the second scratching element female connector is configured to couple with the second base female connector at an angle other than 90 degrees.

18. A pet scratching apparatus, comprising:
a base defining a top face and an aperture;
a scratching element including a bottom side and a top side opposite the bottom side, the scratching element extending from the top face of the base; and
a connection system configured to detachably connect the scratching element to the base, the connection system including:
a male connector defining a projection mounted in a recess defined by the base within the aperture on the top face of the base; and
an opening positioned on a bottom of the scratching element configured to receive the male connector.

19. The apparatus of claim 18, further comprising:
a cap configured to detachably connect to the top of the scratching element, the cap including
a retaining element that extends beyond the circumference of the scratching element; and
a cap male connector projecting from the retaining element; and
an opening defined in the top side of the scratching element configured to receive the cap male connector.

20. The apparatus of claim 18, wherein the scratching element defines a first scratching element and includes an opening defined in the top side of the first scratching element, and further comprising a second scratching element including a second element male member configured to insert into the opening of the first scratching element.
